(19) United States
(12) Patent Application Publication
(10) Pub. No.: US 2023/0211479 A1
(43) Pub. Date: Jul. 6, 2023

(54) Two-speed screw driving device with change of speed via acceleration control

(71) Applicant: ETABLISSEMENTS GEORGES RENAULT, SAINT HERBLAIN (FR)

(72) Inventor: Benjamin Barbaud, SAINT HERBLAIN (PT)

(21) Appl. No.: 18/148,093

(22) Filed: Dec. 29, 2022

(30) Foreign Application Priority Data
Dec. 30, 2021 (FR) 2114700

(51) Int. Cl. B25B 21/00; B25B 23/147; B25B 23/14

(52) U.S. Cl. CPC B25B 21/008; B25B 23/147; B25B 23/141

(57) ABSTRACT

A screw driving device includes: a case; a motor provided with a rotor; an output member capable of driving in rotation an element for driving an element to be screwed; a transmission connecting the rotor to the output member, the transmission including at least one additional gear train capable of being engaged/disengaged; an motor controller. The device includes an element for engaging the additional gear train, which is capable of being in at least: an engagement state in which the additional train is engaged, and a disengagement state in which the additional gear train is not engaged. A reduction ratio of the transmission between the rotor and the output member is different according to whether or not the additional gear train is engaged, the reduction ratio being greater when the additional gear train is engaged.

### 1. FIELD OF THE DISCLOSURE

The field of the disclosure is that of the design and the manufacturing of portable tools intended to be implemented to carry out screw driving (screwing/unscrewing) operations.

More precisely, the disclosure relates to a screw driving device offering several screw driving speeds. This device is more particularly intended for continuous-tightening screwdrivers, the torque of which exceeds 150 N·m (high-torque screwdrivers).

### 2. PRIOR ART

Screw driving devices are routinely used in various industrial sectors to carry out operations of screwing and/or unscrewing of assemblies.

A screw driving operation generally comprises two successive phases, namely:
a pre-screw driving phase during which the element to be tightened is driven at a fast speed until a certain level of pre-tightening torque is reached, then
a slower tightening phase until a target tightening torque and/or a target tightening angle are reached.

The screw driving devices with an electric motor are conventionally associated with control means and comprise a tightening torque and/or tightening angle sensor.

These control means allow to program screw driving strategies, that is to say the parameters of the pre-screw driving and tightening phases, in particular the speeds of rotation of the motor in pre-screw driving and tightening phases, as well as the target torque and/or angle value at the end of tightening. Thus, while a screw driving operation is being carried out, the control means control the motor to drive the element to be tightened at the pre-screw driving speed during the pre-screw driving phase then at the tightening speed during the tightening phase until the target torque and/or angle are reached.

The continuous-tightening screwdrivers, that is to say the screwdrivers that during the tightening apply onto the screw an uninterrupted and increasing torque, integrate a transmission between the motor and the output member driving the screw. This transmission in general consists of one or more planetary gearsets. These planetary gearsets allow to have a sufficient available tightening torque on the output shaft. This torque is the result of the multiplication of the motor torque by the reduction ratio of the transmission and its efficiency.

To be able to reach significant tightening torques, for example greater than 150 N·m, screwdriver manufacturers are thus led to have a significant reduction ratio by having several planetary gearsets in the transmission. This has the disadvantage that the frequency of rotation of the output shaft of the screwdriver becomes relatively low with consequently a long screw driving time that hampers productivity.

Thus the manufacturers of high-torque screwdrivers conceived of having a device integrated into the transmission allowing to short-circuit one of the planetary gearsets during the pre-screw driving. The reduction ratio implemented during the pre-screw driving thus becomes lower than in the rise in torque during the tightening with the benefit of a high frequency of rotation during the pre-screw driving and a high torque during the rise in torque during the tightening. This planetary gearset capable of being short-circuited or disengaged is called additional train.

The pre-screw driving and tightening speeds applied during the pre-screw driving and tightening phases thus assume the implementation of an engageable-disengageable additional gear train that allows to define different reduction ratios between the rotor and the output member according to whether or not it is activated. Thus, the additional gear train is not activated in the pre-tightening phase so that the pre-screw driving speed is fast. Inversely, the additional train is activated during the tightening phase so that the tightening speed is slower and the tightening torque reachable by the screw driving device is higher.

The additional gear train is automatically engaged in a mechanical manner at the end of the pre-tightening phase. For this, in the solutions of the prior art, the transmission integrates an elastic element that allows, when the tightening torque reaches, during the pre-screw driving phase, a predetermined torque threshold for changing speed, to automatically activate the additional gear train.

This type of mechanism is advantageous in that it allows to ensure in a simple and efficient manner a change in screw driving speed automatically. However, this type of technology can be further improved.

Indeed, the predetermined tightening torque threshold for changing speed starting at which the additional train is automatically activated cannot be parameterized insofar as it depends on the dimensioning of the elastic element integrated into the transmission. Consequently, this type of technology does not allow to obtain polyvalent screwdrivers adaptable to various screw driving operations requiring a change of speed after reaching a pre-tightening threshold having different values.

### 3. SUMMARY

For this, an exemplary embodiment of the present disclosure proposes a screw driving device comprising:
a case;
a motor provided with a rotor;
an output member capable of driving in rotation an element for driving an element to be screwed;
a transmission connecting said rotor to said output member, said transmission comprising at least one additional gear train capable of being engaged/disengaged;
means for controlling said motor;
   said device comprising means for engaging said additional gear train, said engagement means being capable of being in at least:
an engagement state in which said additional train is engaged, and
a disengagement state in which said additional gear train is not engaged,
   the reduction ratio of said transmission between said rotor and said output member being different according to whether or not said additional gear train is engaged, said reduction ratio being greater when said additional gear train is engaged.

According to an exemplary embodiment, said means for controlling said motor are configured to generate a predetermined acceleration or deceleration of said rotor, said predetermined acceleration or deceleration acting on said engagement means to make them go from one to the other of their states.

Thus, according to this aspect, an exemplary embodiment is based on an original approach according to which the engagement from one speed to the other is carried out, independently of the value of the tightening torque reached, according to the acceleration-deceleration of the motor.

An exemplary embodiment of the present disclosure thus provides broad polyvalence in the choice of the time at which the change of speed occurs since it suffices for this to play with the value of the acceleration/deceleration of the motor, this being possible by simply acting on the control of the motor. The change of speed is thus according to an exemplary embodiment completely independent of the tightening torque delivered by the device.

According to one possible feature, said engagement means comprise a selection member mobile in rotation with respect to said rotor between at least two positions of engagement/disengagement of said additional gear train, said predetermined acceleration or deceleration acting on said selection member to make it go from one to the other of its positions.

According to one possible feature, a device according to an exemplary embodiment comprises means for rotationally linking said selection member with said rotor, said rotational-linking means ensuring, when said selection member occupies one of its positions, a link in rotation of said selection member with said rotor as long as said motor delivers an acceleration-deceleration lower than a predetermined change of speed acceleration-deceleration threshold, the delivery by said motor of an acceleration/deceleration greater than said predetermined change of speed acceleration-deceleration threshold causing the rotation of said selection member from one to the other of its positions.

According to one possible feature, said rotational-linking means comprise at least one blocking element constrained to rotate with said rotor and capable of being housed alternatingly in two housings having a complementary shape made in said selection member, said blocking element being mobile according to an axis orthogonal to the axis of said rotor, against the effect of resilient return means, between at least:
a rotational-linking position in which said blocking element is housed in one or the other of said housings so that said rotor and said selection member are linked in rotation, and
a release position in which said blocking element is not housed in any of said housings so that said rotor and said selection member are not linked in rotation.
   According to one possible feature:
said rotational-linking means are capable of transmitting a predetermined limit torque CI beyond which said rotor and said selection member are no longer linked in rotation and can no longer transmit torque,
said selection member has an inertia Jos according to its axis of rotation;
the value of said change of speed acceleration-deceleration being equal to the quotient of said limit torque CI divided by said inertia Jos.

According to one possible feature, said one planetary gearset comprises a sun gear constrained to rotate with said rotor, a carrier constrained to rotate with said output member, and an inner toothed ring gear meshing with planet gears carried by said carrier, said ring gear being:
mobile in rotation with respect to said case in said state of disengagement of said additional gear train, and
blocked in rotation with respect to said case in said state of engagement of said additional gear train.

According to one possible feature, a device according to an exemplary embodiment comprises a first pair of unidirectional clutches comprising said case and said inner ring gear.

According to one possible feature, a device according to an exemplary embodiment comprises a second pair of unidirectional clutches comprising said rotor and a ring for driving in rotation,
said second pair of unidirectional clutches meshing said rotor with said ring for driving in rotation when said engagement means are in said state of disengagement of said additional gear train and said rotor rotates in the screwing direction, said first pair of unidirectional clutches leaving said inner toothed ring gear free in rotation,
said second pair of unidirectional clutches not meshing said rotor with said drive ring when said engagement means are in said state of engagement of said additional gear train and said rotor rotates in the screwing direction, said first pair of unidirectional clutches blocking said inner toothed ring gear in rotation.

According to one possible feature:
said second pair of unidirectional clutches does not mesh said rotor with said drive ring when said engagement means are in said state of disengagement of said additional gear train and said rotor rotates in the unscrewing direction, said first pair of unidirectional clutches blocking said inner toothed ring gear in rotation,
said second unidirectional clutch does not mesh said rotor with said drive ring when said engagement means are in said state of engagement of said additional gear train and said rotor rotates in the unscrewing direction, said first pair of unidirectional clutches leaving said inner toothed ring gear free in rotation.

According to one possible feature, a device according to an exemplary embodiment comprises at least one member for locking in rotation, constrained to rotate with said rotor, and mobile between:
a position of blocking in rotation, occupied when said engagement means are in said state of disengagement of said additional gear train, in which it cooperates with a blocking housing made in said drive ring so that said ring and said rotor are linked in rotation, and
a position of unblocking in rotation, taken when said engagement means are in said state of selection of said additional gear train, in which it does not cooperate with said blocking housing made in said drive ring so that said ring and said rotor are not linked in rotation.

According to one possible feature:
when said rotational-locking member occupies said rotational-blocking position and said rotor rotates in the screwing direction, said first unidirectional clutch leaves said inner toothed ring gear free in rotation,
when said rotational-locking member occupies said rotational-unblocking position and said rotor rotates in the screwing direction, said first unidirectional clutch blocks said inner toothed ring gear in rotation.

According to one possible feature:
when said rotational-locking member occupies said rotational-blocking position and said rotor rotates in the unscrewing direction, said first unidirectional clutch leaves said inner toothed ring gear free in rotation,
when said rotational-locking member occupies said rotational-unblocking position and said rotor rotates in the unscrewing direction, said first unidirectional clutch blocks said inner toothed ring gear in rotation.

### 4. DESCRIPTION OF THE DRAWINGS

Other features and advantages of the present disclosure will appear upon reading the following description of specific embodiments, given as a simple illustrative and non-limiting example, and of the appended drawings among which:

FIG. 1 illustrates a longitudinal cross-sectional view of a device according to a first embodiment;

FIG. 2 illustrates a cross-section according to the axis B-B of FIG. 1 when the selection means are in a first position of selection-deselection of the additional gear train;

FIG. 3 illustrates a cross-section according to the axis C-C of FIG. 1 when the selection means are in a first position of selection-deselection of the additional gear train;

FIG. 4 illustrates a cross-section according to the axis D-D of FIG. 1 when the selection means are in a first position of selection-deselection of the additional gear train;

FIG. 5 illustrates a cross-section according to the axis E-E of FIG. 1 when the selection means are in a first position of selection-deselection of the additional gear train;

FIG. 6 illustrates a cross-section according to the axis B-B of FIG. 1 when the selection means are in a second position of selection-deselection of the additional gear train;

FIG. 7 illustrates a cross-section according to the axis C-C of FIG. 1 when the selection means are in a second position of selection-deselection of the additional gear train;

FIG. 8 illustrates a cross-section according to the axis D-D of FIG. 1 when the selection means are in a second position of selection-deselection of the additional gear train;

FIG. 9 illustrates a cross-section according to the axis E-E of FIG. 1 when the selection means are in a second position of selection-deselection of the additional gear train;

FIG. 10 illustrates a perspective view of a selection member of a device according to a first embodiment;

FIG. 11 illustrates a perspective view of a drive shaft of a device according to a first embodiment;

FIG. 12 illustrates a perspective view of a ring for driving in rotation of a device according to a first embodiment;

FIG. 13 illustrates a perspective view of a ring gear of a device according to a first embodiment;

FIG. 14 illustrates a perspective view of rollers;

FIG. 15 illustrates a longitudinal cross-sectional view of a device according to a second embodiment when the selection means are in their position of deselection of the additional gear train;

FIG. 16 illustrates a cross-section according to the axis B-B of FIG. 15;

FIG. 17 illustrates a cross-section according to the axis C-C of FIG. 15;

FIG. 18 illustrates a cross-section according to the axis D-D of FIG. 15;

FIG. 19 illustrates a cross-section according to the axis E-E of FIG. 15;

FIG. 20 illustrates a cross-section according to the axis F-F of FIG. 15;

FIG. 15 illustrates a longitudinal cross-sectional view of a device according to a second embodiment when the selection means are in their position of selection of the additional gear train;

FIG. 22 illustrates a cross-section according to the axis B-B of FIG. 21;

FIG. 23 illustrates a cross-section according to the axis C-C of FIG. 21;

FIG. 24 illustrates a cross-section according to the axis D-D of FIG. 21;

FIG. 25 illustrates a cross-section according to the axis E-E of FIG. 21;

FIG. 26 illustrates a cross-section according to the axis F-F of FIG. 21;

FIG. 27 illustrates a perspective view of a locking member according to the second embodiment;

FIG. 28 illustrates a perspective view of a ring gear of a device according to a first embodiment;

FIG. 29 illustrates a perspective view of a drive shaft of a device according to a first embodiment;

FIG. 30 illustrates a perspective view of a rotational-selection member of a device according to a first embodiment;

FIG. 31 illustrates a perspective view of a drive ring of a device according to a second embodiment;

FIG. 32 illustrates a method for controlling a device according to an exemplary embodiment.

### 5. DESCRIPTION OF SPECIFIC EMBODIMENTS

### 5.1. First Embodiment

5.1.1. Architecture

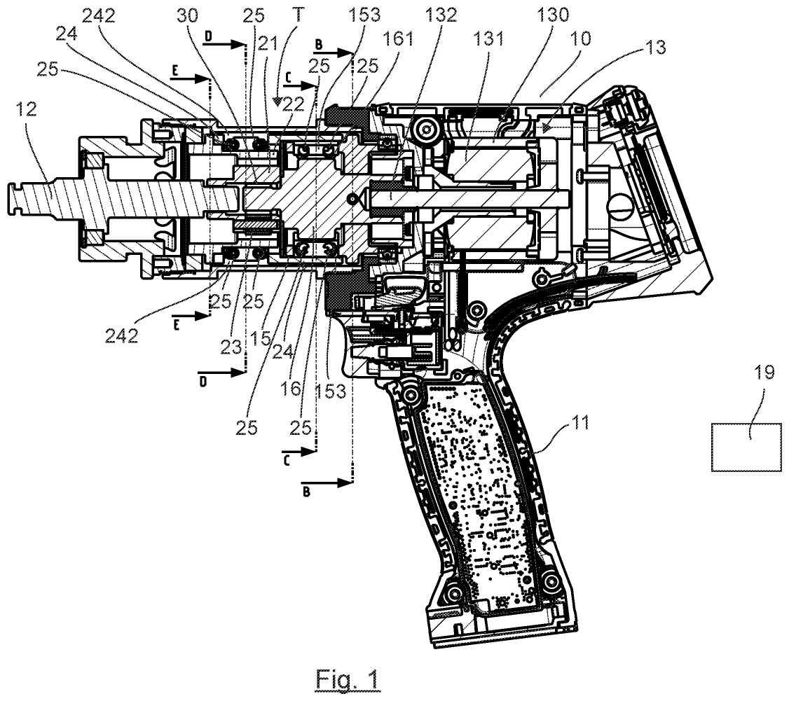

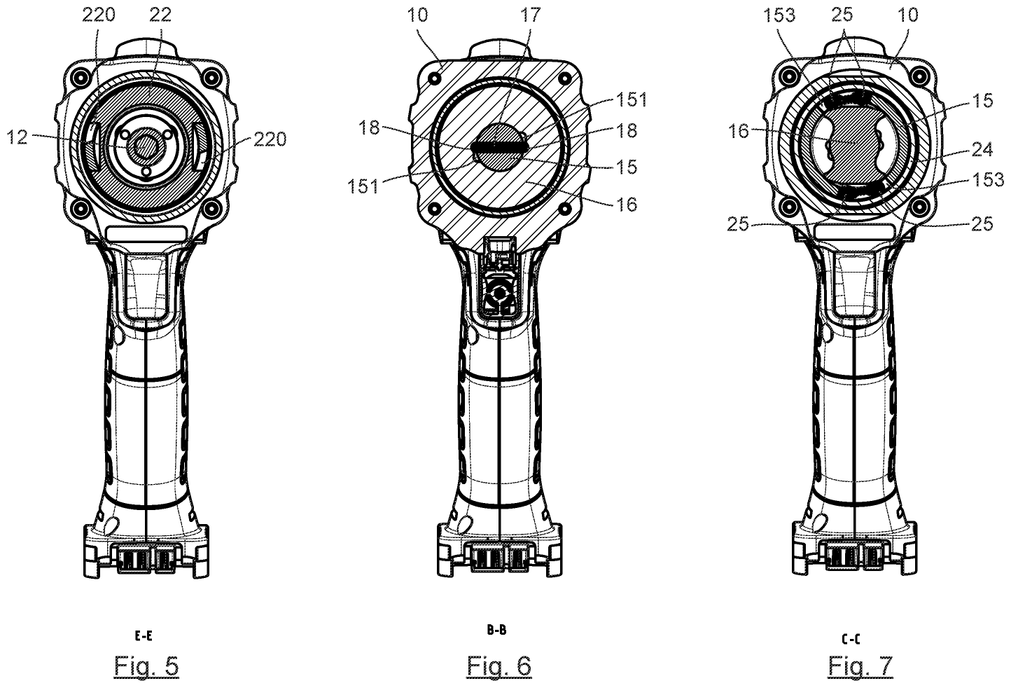

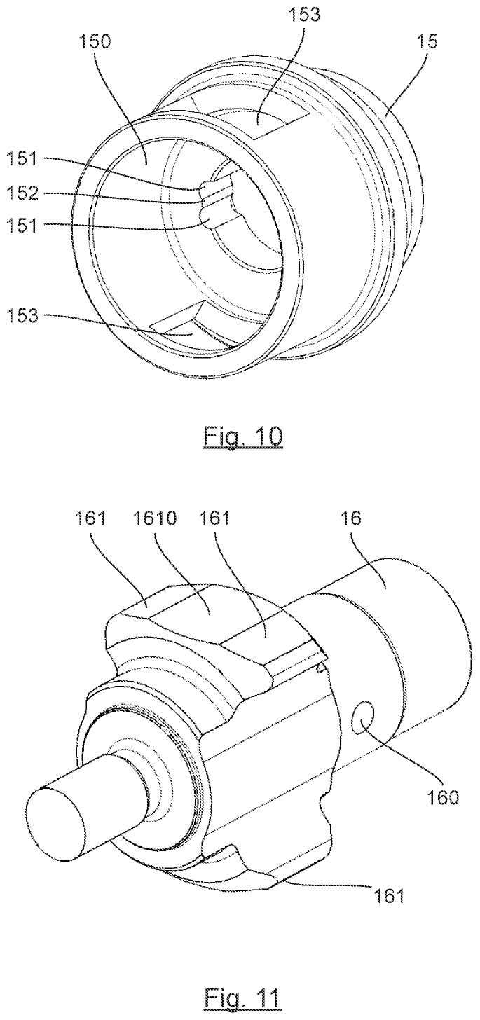

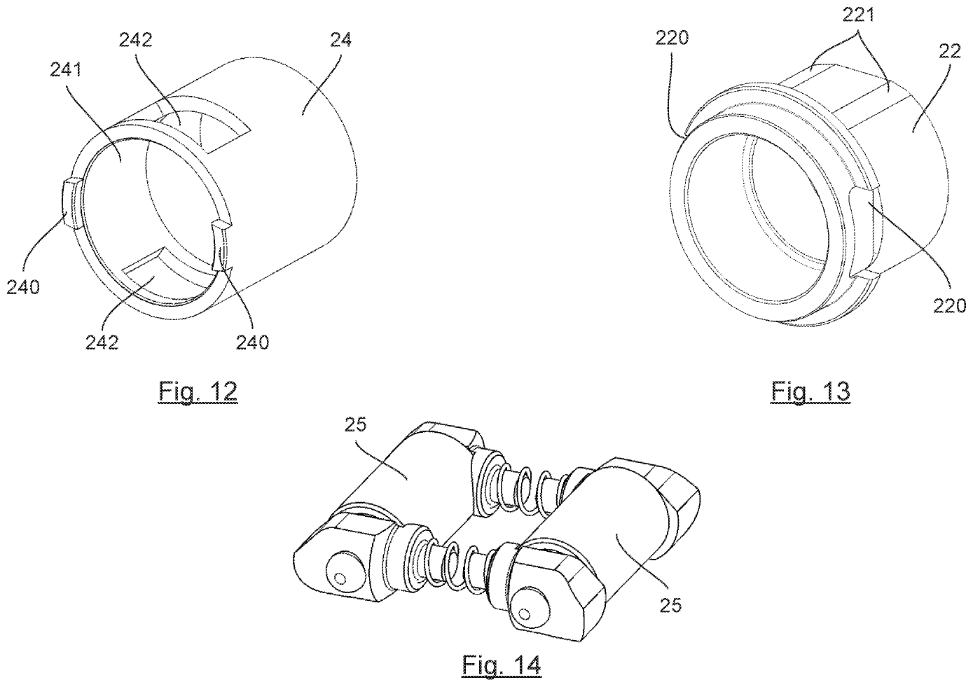

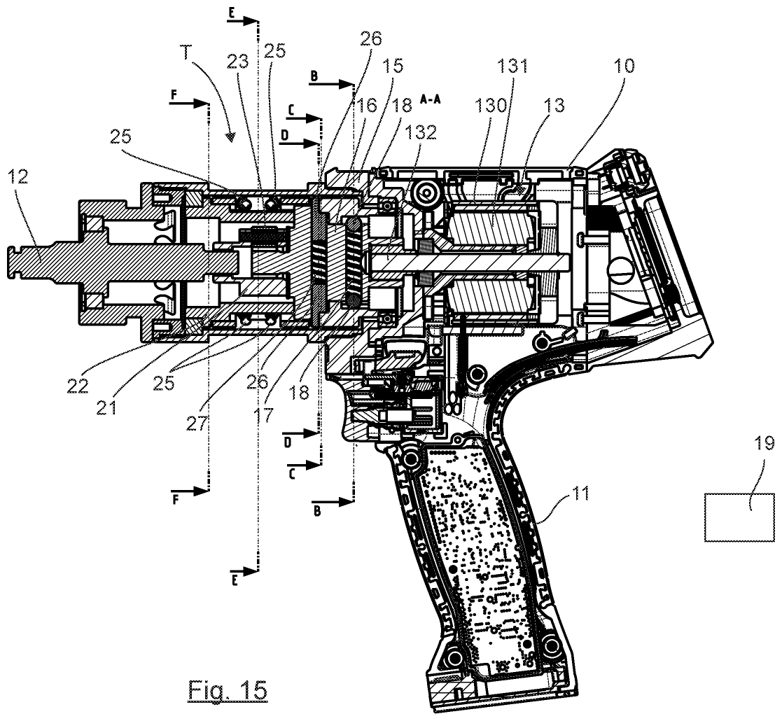

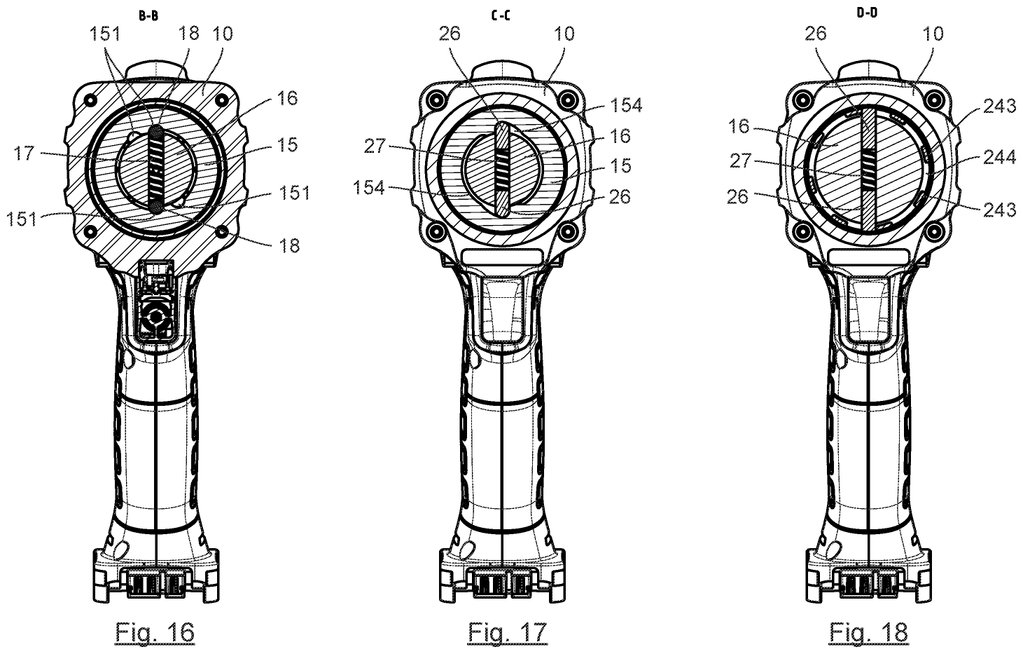

In relation to FIGS. 1 to 14, an example of a first embodiment of a screw driving (screwing/unscrewing) device according to the present disclosure is presented.

As shown, such a screw driving device conventionally comprises a case 10. Here this is a case of the handle-gun type in which the axis of the handle 11 forms an angle with the axis of the output member 12. It could alternatively be a case in which the axis of the handle is the same as the axis of the output member.

The case 10 houses an electric motor 13 comprising a stator 130 and a rotor 131 provided with a motor shaft 132.

The device comprises an output member 12 placed at the end of the case 10. This output member 12 is capable of driving in rotation an element for driving an element to be screwed, in particular a screw driving socket or other.

The device comprises a transmission T connecting the shaft 132 of the rotor 131 to the output member 12 so as to drive the latter in rotation.

The transmission T comprises a two-speed mechanism 14 that comprises two transmission chains having different transmission ratios. For this, the transmission T comprises an additional gear train capable of being engaged/disengaged. As will be described in more detail below, this additional train comprises here a planetary gearset that can be deactivated by making its inner ring gear free in rotation or activated by blocking its ring gear in rotation.

The two-speed mechanism 14 comprises means for engaging the additional gear train, these means being capable of being in at least:
an engagement state in which the additional train is engaged, and
a disengagement state in which the additional gear train is disengaged.

The reduction ratio of the transmission between the rotor and the output member is different according to whether or not the additional gear train is engaged, the reduction ratio being greater when the additional gear train is engaged. In this way, for a given frequency of rotation of the rotor, the frequency of rotation of the output member is higher when the additional gear train is not activated and slower when it is activated so that the tightening torque capable of being delivered by the device is higher when the additional gear train is activated.

The engagement means comprise a selection member 15 mobile between at least a first and a second position of selection/deselection of the additional gear train.

In this embodiment, the direction of rotation of the rotor has an effect on the engagement of the additional gear train. Indeed:
when the rotor rotates in the direction of the screwing and the selection member is in a first of its positions, the additional gear train is deactivated: the device allows to carry out a pre-screw driving at a fast speed;
when the rotor rotates in the direction of the unscrewing and the selection member is in a first of its positions, the additional gear train is activated: the device allows to carry out an unscrewing at a slow speed;
when the rotor rotates in the direction of the screwing and the selection member is in a second of its positions, the additional gear train is activated: the device allows to carry out a tightening at a slow speed and greater torque;
when the rotor rotates in the direction of the unscrewing and the selection member is in a second of its positions, the additional gear train is deactivated: the device allows to carry out an unscrewing at a fast speed.

This two-speed mechanism comprises a drive shaft 16 linked in rotation to the shaft 132 of the rotor 131. These two components could in one alternative form a single part.

An inner longitudinal bore 150 housing the drive shaft 16 passes through the selection member 15. The selection member 15 is mounted movably in rotation about the drive shaft 16 between two extreme positions corresponding to its two selection positions.

In each of these two extreme positions, the selection member 15 is linked in rotation to the drive shaft 16 by rotational-linking means. For this, a through-hole 160 passes through the drive shaft 16, made along an axis perpendicular to its longitudinal axis. This hole 160 houses a resilient return means which comprises in this embodiment a compression spring 17. At each end of the compression spring 17 a blocking element is placed. These blocking elements are in this embodiment made by blocking balls 18.

The selection member 15 comprises at the periphery of the inner bore 150 housing the drive shaft 16 two diametrically opposite pairs of blocking housings 151. The housings 151 of each pair are connected by a groove 152.

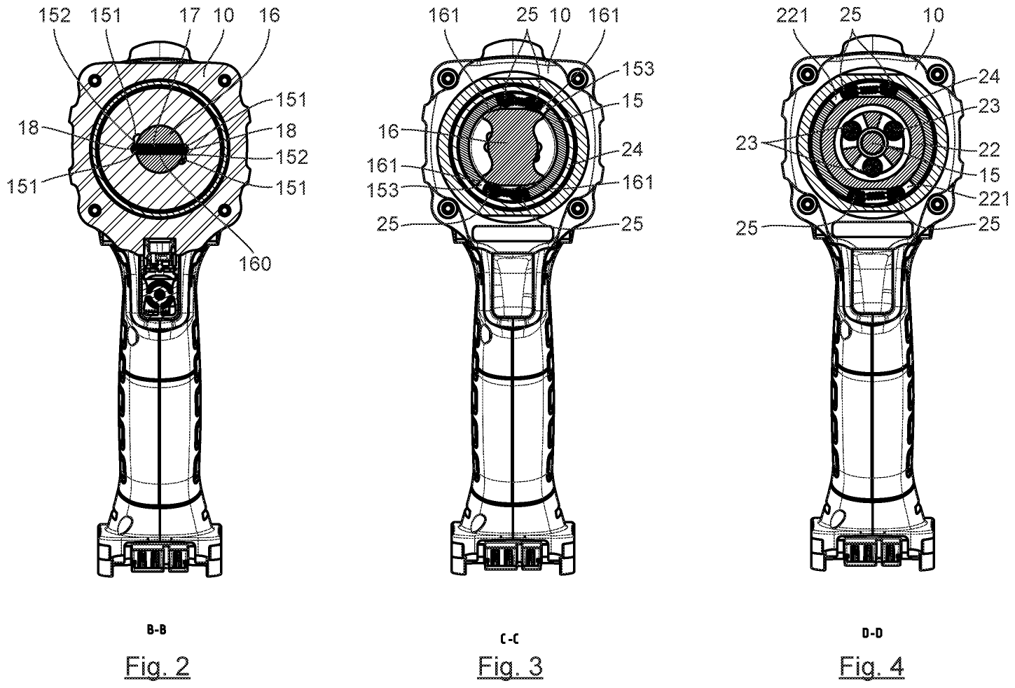

The blocking balls 18 are mobile according to an axis orthogonal to the axis of the drive shaft 16, against the effect of the resilient return means 17, between at least:
a rotational-linking position in which the balls 18 are housed in two of the diametrically opposite blocking elements 151 so that the drive shaft 16 and the selection member 15 are linked in rotation (cf. FIGS. 2 and 6), and
a release position in which the balls 18 are not housed in any of the blocking housings 151, but are in the grooves 152, so that the drive shaft 16 and the selection member 15 are not linked in rotation.

When the selection member 15 is in its first position, the blocking balls 18 are housed in two first of the opposite housings 151 (cf. FIG. 2). When the selection member 15 is in its second position, the balls 18 are in two other of the opposite housings 151 (cf. FIG. 6).

When the balls are in their rotational-blocking position, the rotational-linking means are capable of transmitting a predetermined limit torque CI beyond which the balls go into their release position in which the drive shaft and the selection member are no longer linked in rotation and can no longer transmit torque. This predetermined torque depends in particular on the stiffness of the spring 17, the size of the balls, the geometry of the blocking housings and the grooves. This torque can be conventionally determined by calculation or empirically.

The device conventionally comprises means for measuring the tightening torque delivered by the device at the output member. These measuring means can for example comprise a torque sensor placed in the transmission between the rotor and the output member or a sensor of current consumed by the motor.

The device conventionally comprises means for controlling the motor 19. These means allow to control the motor by controlling in particular its electric power supply. They can be totally or partly located inside the case or outside the latter.

The means 19 for controlling the motor allow, by acting on the acceleration/deceleration of the rotor 131 of the motor 13, to make the engagement means go from one to the other of their states, i.e. to make the selection member 15 go from one to the other of its positions with respect to the drive shaft 16.

To allow the engagement means to go from one to the other of their positions, the acceleration/deceleration generated by the motor must be greater than the quotient of the limit torque CI transmittable by the rotational-linking means divided by the inertia Jos of the selection member according to its axis of rotation. This acceleration/deceleration is called change of speed acceleration/deceleration insofar as it allows to engage/disengage the additional gear train and thus modify the reduction ratio of the transmission between the rotor and the output member.

While a screw driving operation is being carried out, the motor conventionally produces accelerations and acceleration variations, in particular upon starting. The acceleration/deceleration that induces the passage of the engagement means from one to the other of their states should therefore be sufficiently discriminating, i.e. distant and more precisely greater, to the accelerations conventionally capable of occurring, for example upon starting or stopping, to not engender in an untimely manner involuntary passages of the selection means from one to the other of their states.

The transmission comprises a planetary gearset comprising a sun gear 20 constrained to rotate with the drive shaft 16, a carrier 21 constrained to rotate with the output member 12, and an inner toothed ring gear 22 meshing with planet gears 23 carried by the carrier 21. In alternatives, the carrier can be linked in rotation with the input of another planetary gearset or of a cascade of planetary gearsets, the output of which would be linked in rotation with the output member.

The two-speed mechanism comprises a ring for driving in rotation 24 the ring gear 22.

This ring for driving in rotation 24 comprises two male teeth 240 cooperating with two female teeth 220 made in the ring gear 22 so that the ring gear 22 and the ring for driving in rotation 24 are linked in rotation according to the axis of the rotor 131. However, there is play between the male and female teeth to allow the unblocking of the unidirectional clutches.

A longitudinal inner bore 241 housing on one side the selection member 15 and on the other side the ring gear 22 passes through the ring for driving in rotation 24. Two diametrically opposite openings 242 located at the ring gear 22 pass through the peripheral wall of the drive ring 24.

Two diametrically opposite openings 153 pass through the selection member 15 at its periphery.

The ring gear 22 has, at its periphery, two pairs of diametrically opposite blocking ramps 221.

The device comprises a first pair of unidirectional clutches and a second pair of unidirectional clutches. The unidirectional clutches of each pair are antagonistic, i.e. they operate in opposite directions.

The first pair of unidirectional clutches comprises the ring gear 22, the case 10, and rollers 25 housed, between the ring gear 22 and a bore formed in the case 10, in openings 242 of the ring for driving in rotation 24 at the ramps 221 of the ring gear 22. The ring for driving in rotation 24 allows, according to its position, to activate or not the unidirectional clutches of this pair.

The drive shaft 16 has, at its periphery, two pairs of diametrically opposite blocking ramps 161.

The second pair of unidirectional clutches comprises the drive ring 24, the drive shaft 16, and rollers 25 housed, between the drive shaft 16 and the inner bore 241 of the drive ring 24, in the openings 153 of the selection member 15, at the blocking ramps 161 of the drive shaft 16. The selection member 15 allows, according to its position, to activate or not the unidirectional clutches of this pair.

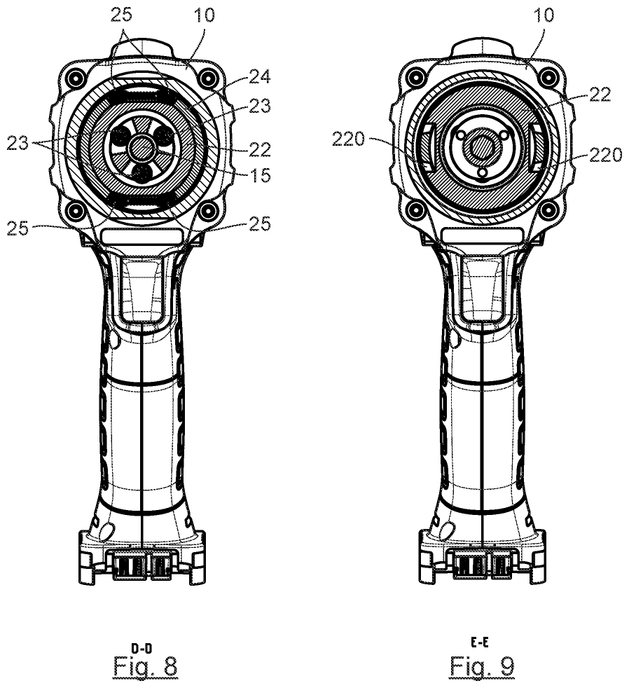

The position and the inclination of the ramps 161 of the drive shaft 16 as well as the position and the inclination of the ramps 221 of the ring gear 22 are chosen in such a way that:
the second pair of unidirectional clutches meshes the drive shaft 16 with the drive ring 24 when the engagement means are in the state of disengagement of the additional gear train and the rotor 131 rotates in the screwing direction, the first pair of unidirectional clutches leaving the inner toothed ring gear 22 free in rotation (cf. FIGS. 3 and 4), the ring gear 22 thus rotates at the same speed as the drive shaft: fast pre-screwing;
the second pair of unidirectional clutches does not mesh the drive shaft 16 with the drive ring 24 when the engagement means are in the state of engagement of the additional gear train and the rotor 131 rotates in the screwing direction, the first pair of unidirectional clutches blocking in rotation said inner toothed ring gear 22 (cf. FIGS. 7 and 8): tightening and at higher torque;
the second pair of unidirectional clutches meshes the drive shaft 16 with the drive ring 24 when the engagement means are in the state of disengagement of the additional gear train and the rotor 131 rotates in the unscrewing direction, the first pair of unidirectional clutches blocking in rotation the inner toothed ring gear 22 (cf. FIGS. 3 and 4), the first pair of unidirectional clutches leaving the inner toothed ring gear 22 free in rotation: fast unscrewing;
the second pair of unidirectional clutches does not mesh the drive shaft 156 with the drive ring 24 when the engagement means are in the state of engagement of the additional gear train and the rotor 131 rotates in the unscrewing direction (cf. FIGS. 7 and 8): slow unscrewing.

In alternatives, one or more permanent, i.e. non-deactivatable, gear trains, for example planetary, can be disposed between the carrier 21 and the output member 12.

When the additional gear train is disengaged, the reduction ratio of the transmission is equal to 1 insofar as the drive shaft 16 and the carrier rotate at the same frequency of rotation, or to the reduction ratio of the permanent gear train or to their product if several permanent trains are implemented.

When the additional gear train is engaged, the reduction ratio of the transmission is equal to the reduction ratio of the additional planetary gearset, or to its product with the reduction ratio(s) of the permanent gear train(s) implemented if applicable.

5.1.2. Operation

A screw driving operation comprising a phase of pre-tightening at a fast speed followed by a phase of tightening at a slower speed is described below.

Before starting a screw driving operation, the operator tasked with it programs in the controller, for example via a touch screen, a keyboard, a smartphone or other, the value of the predetermined change of speed torque threshold CchangementVitesse which, when it is reached at the output of the screw driving device during a pre-screw driving phase, engenders a change of speed and the passage into the tightening phase. The operator can also program the value of the target torque to which they desire the assembly to be screwed to be tightened after the tightening phase.

Upon starting of the screw driving device with a view to carrying out such a screwing/unscrewing operation, the control means control the motor in such a way that it generates, in the direction of the screwing, a change of speed acceleration w, the value of which is greater than the quotient of the predetermined limit torque CI

$$Cl ( \dot{w} > \frac{Cl}{Jos} ) ,$$

beyond which the balls go into their release position in which the drive shaft and the selection member are no longer linked in rotation, divided by the inertia Jos of the selection member. In this way, the means for engagement of the additional gear train are placed in their disengagement state. The control means then control the motor so as to make it rotate in the direction of the screwing to carry out the pre-screw driving phase.

In the state of disengagement of the additional gear train, the second pair of unidirectional clutches, given the relative position of the selection member 15 with respect to the drive shaft 16, meshes the drive shaft 16 with the ring for driving in rotation 24 when the rotor of the motor is driven in rotation in the direction of the screwing which in this embodiment is the counterclockwise direction when the screw driving device is viewed from the output member towards the rear of the screwdriver.

The ring for driving in rotation 24 thus rotates in the counterclockwise direction and drives the ring gear 22 in rotation in this direction, the second pair of unidirectional clutches not meshing the ring gear 22 with the case so that the ring gear is free to rotate.

The ring gear 22 meshes with the planet gears 23 just like the sun gear 20 constrained to rotate with the drive shaft 16. The ring gear 22 thus rotates at the same frequency of rotation as the sun gear 20. As a result, the carrier 21 rotates at the same frequency as the drive shaft 16. Thus, the output member 12 is driven in rotation in the direction of the screwing at a fast speed.

The control means control the motor in such a way that the output member is driven in rotation at a fast speed during the pre-screw driving phase until the tightening torque delivered by the screw driving device reaches the predetermined change of speed torque threshold CchangementVitesse.

When the control means detect via the torque sensor that this threshold has been reached, the control means brake the motor in order to engender a change of speed deceleration, the value of which is greater than the quotient of the predetermined limit torque CI divided by the inertia Jos of the selection member. In this way, the selection means are moved into their state of engagement of the additional gear train.

When this deceleration is generated, the balls 18 exit their housings 151 to circulate in the grooves 152 until they are housed in the other blocking housings 151 of the selection member 15. The selection means are thus in their state of engagement of the additional gear train.

The control means then control the motor so that it reaches its nominal frequency of rotation while generating, however, an acceleration \dot{w} lower than the change of speed acceleration in order to guarantee that the selection means remain in their state of engagement of the additional gear train; in other words, the acceleration \dot{w} must be such that

$$\dot{w} < \frac{Cl}{Jos} .$$

The control means men control the motor so as to make it rotate in the direction of the screwing to carry out the tightening phase.

In the state of engagement of the additional gear train, when the rotor rotates in the screwing direction, the second pair of unidirectional clutches does not mesh the drive shaft 16 with the ring for driving in rotation 24 so that the latter is immobile in rotation. The first pair of unidirectional clutches meshes the case 10 with the ring gear 22 so that the latter is immobilized in rotation.

The drive shaft 16 drives in rotation in the counterclockwise direction the sun gear 20 which meshes with the planet gears 23 rigidly connected to the carrier 21 which rotates to drive in rotation the output member 12 in the screwing direction according to a slower speed while providing a higher available torque.

The control means thus control the motor until they detect, via the torque sensor, that the target tightening torque to which it is desired to tighten the assembly currently being screwed has been reached.

The torque sensor can be a measurement of current. It could be possible to cause the engagement disengagement of the additional train on the basis of a reason other than the measurement of torque, for example a measurement of time.

When the target torque has been reached, the control means brake the motor preferably with a deceleration lower than the change of speed deceleration until the frequency of rotation of the motor becomes zero. However, braking with a greater deceleration would not have an effect given that the torque of sliding of the selection member 15 with respect to the drive shaft 16 is substantially greater when the balls no longer have the opportunity to go into a groove 152.

At an equal frequency of rotation of the motor during the phases of fast pre-tightening and slow tightening, the difference in speed of the output member is due to the fact that during the pre-screw driving phase, the ring gear is free in rotation whereas it is immobile in rotation during the tightening phase. In other words, the additional gear train is disengaged during the pre-screw driving phase but engaged during the tightening phase. Thus, the transmission chains used during these two phases have different transmission ratios.

In this embodiment, the motor rotates in the counterclockwise direction for a screwing operation and in the clockwise direction for an unscrewing operation viewed from the output member towards the rear of the screwdriver.

If an acceleration is required in order for the selection means to go from their state of disengagement of the additional gear train to their state of engagement of the additional gear train, a deceleration is necessary to go from their state of disengagement of the additional gear train to their state of engagement of the additional gear train to their state of disengagement of the additional gear train to their state of disengagement of the additional gear train, and vice versa.

Moreover, the driving of the motor in the unscrewing direction while the means for engagement of the additional gear train are placed in their disengagement state allow to carry out a driving in rotation of the output member in the direction of the unscrewing at a slow speed.

The driving of the motor in the unscrewing direction while the means for engagement of the additional gear train are placed in their engagement state allow to carry out a driving in rotation of the output member in the direction of the unscrewing at a fast speed.

### 5.2. Second Embodiment

5.2.1. Architecture

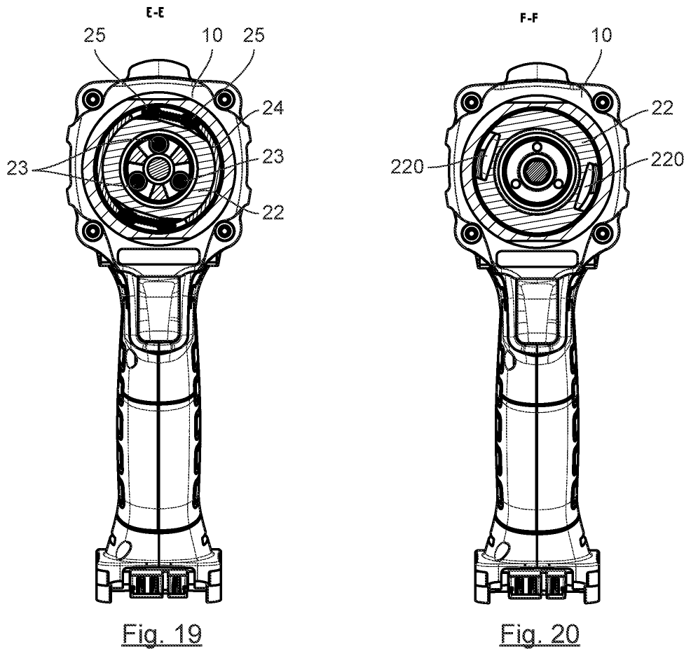

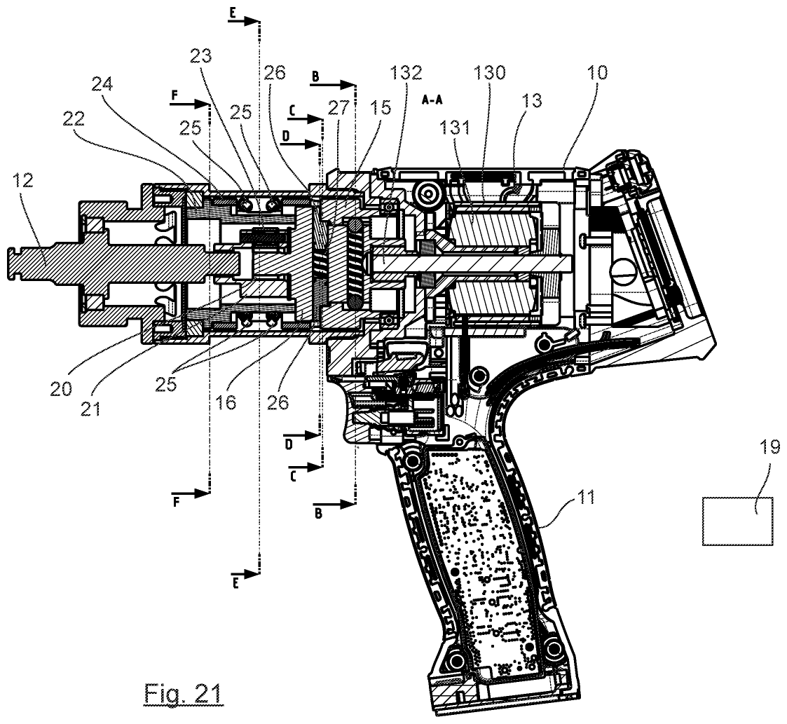

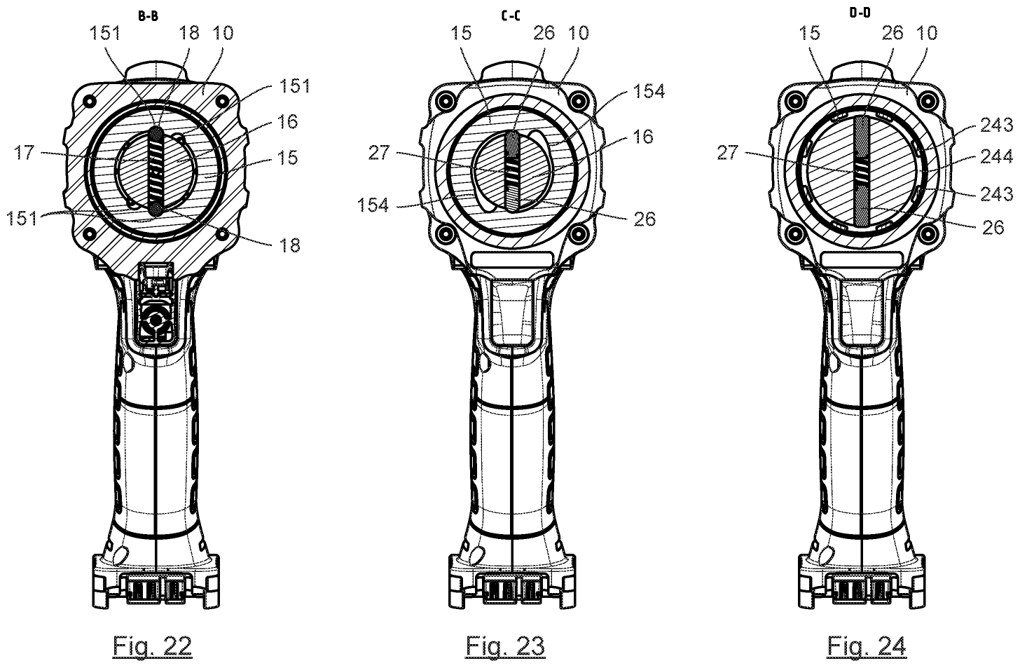

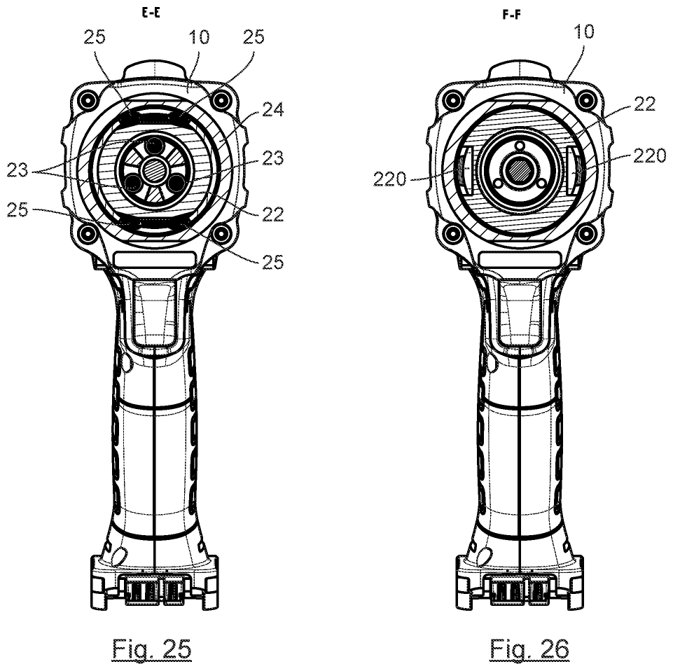

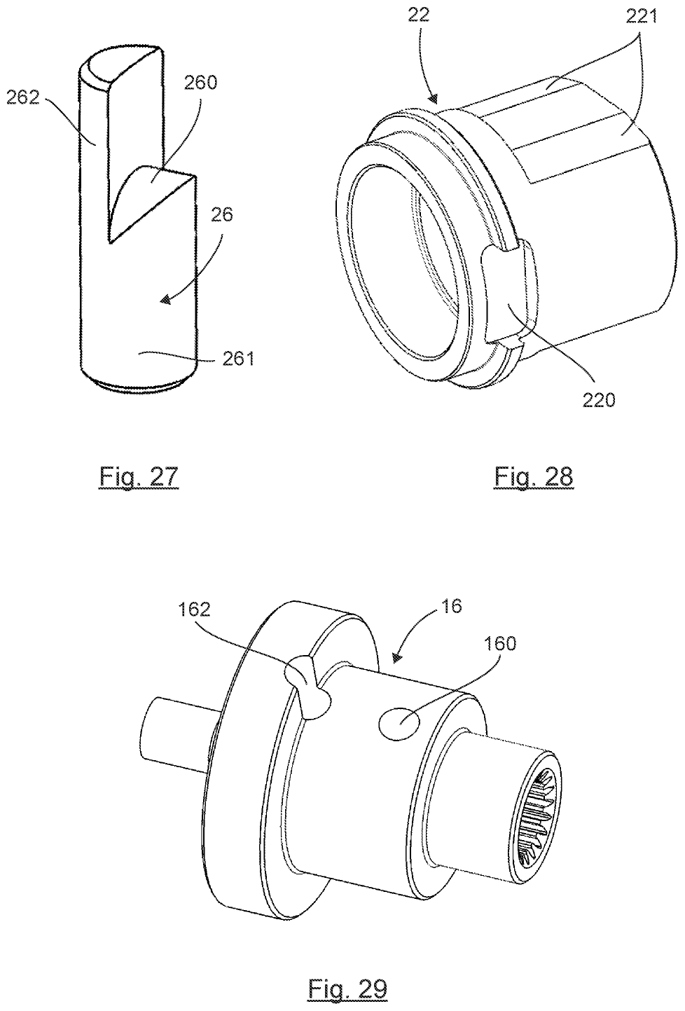

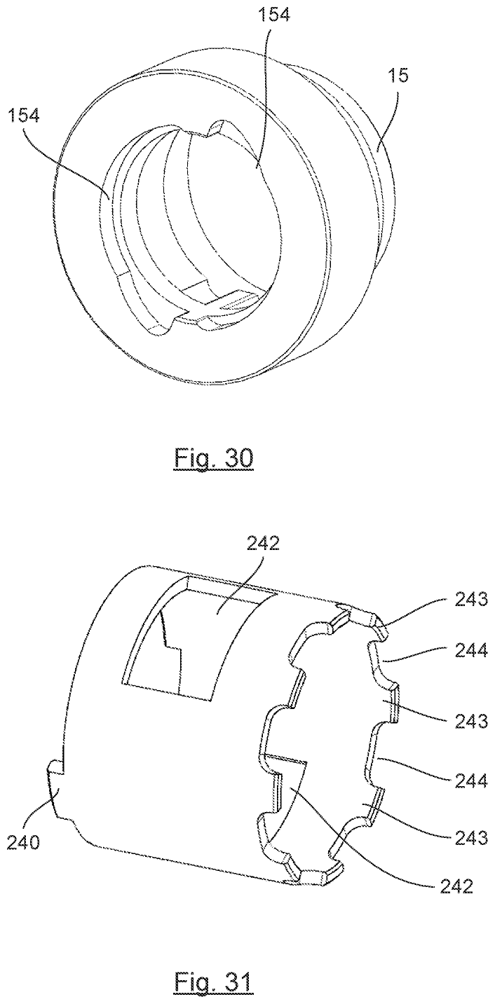

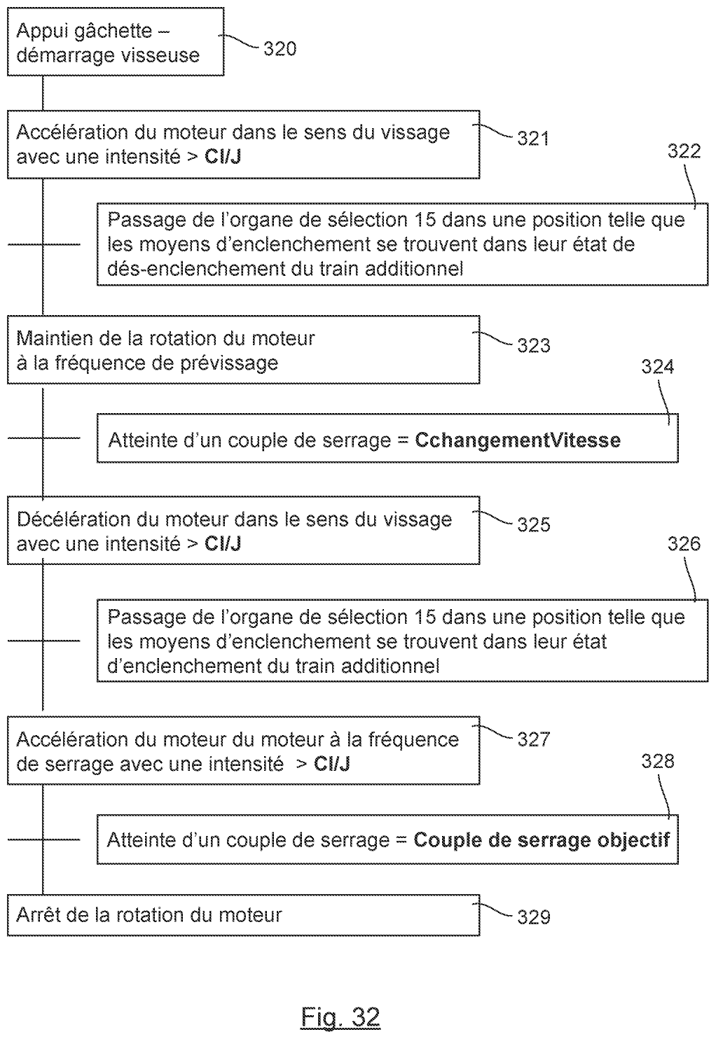

In relation to FIGS. 15 to 31, an example of a second embodiment of a screw driving device according to the present disclosure is presented.

As shown, such a screw driving device conventionally comprises a case 10. Here this is a case of the handle-gun type in which the axis of the handle 11 forms an angle with the axis of the output member 12. It could alternatively be a case in which the axis of the handle is the same as the axis of the output member.

The case 10 houses an electric motor 13 comprising a stator 130 and a rotor 131 provided with a motor shaft 132.

The device comprises an output member 12 placed at the end of the case 10. This output member 12 is capable of driving in rotation an element for driving an element to be screwed, in particular a screw driving socket or other.

The device comprises a transmission T connecting the shaft 132 of the rotor 131 to the output member 12 so as to drive the latter in rotation.

The transmission T comprises a two-speed mechanism that comprises two transmission chains having different transmission ratios. For this, the transmission T comprises an additional gear train capable of being engaged/disengaged. As will be described in more detail below, this additional train comprises here a planetary gearset that can be deactivated by making its inner ring gear free in rotation or activated by blocking its ring gear in rotation.

The two-speed mechanism comprises means for engaging the additional gear train, these means being capable of being in at least:
an engagement state in which the additional train is engaged, and
a disengagement state in which the additional gear train is disengaged.

The reduction ratio of the transmission between the rotor and the output member is different according to whether or not the additional gear train is engaged, the reduction ratio being greater when the additional gear train is engaged. In this way, for a given frequency of rotation of the rotor, the frequency of rotation of the output member is higher when the additional gear train is not activated and slower when it is activated so that the tightening torque capable of being delivered by the device is higher when the additional gear train is activated.

The engagement means comprise a selection member 15 mobile between at least:
a position of selection of the additional gear train, and
a position of deselection of the additional gear train.

In this embodiment, the direction of rotation of the rotor has an effect on the engagement of the additional gear train.

This two-speed mechanism comprises a drive shaft 16 linked in rotation to the shaft 132 of the rotor. These two components could in one alternative form a single part.

An inner longitudinal bore 150 housing the drive shaft 16 passes through the selection member 15. The selection member 15 is mounted movably in rotation about the drive shaft 16 between two extreme positions corresponding to its two selection positions.

In each of these two extreme positions, the selection member 15 is linked in rotation to the drive shaft 16 by rotational-linking means. For this, a first through-hole 160 passes through the drive shaft 16, made along an axis perpendicular to its longitudinal axis. This hole 160 houses a resilient return means which comprises in this embodiment a compression spring 17. At each end of the compression spring a blocking element is placed. These blocking elements are in this embodiment made by blocking balls 18.

The selection member 15 comprises at the periphery of the inner bore 150 housing the drive shaft 16 two diametrically opposite pairs of blocking housings 151. The housings 151 of each pair are connected by a groove 152.

The blocking balls 18 are mobile according to an axis orthogonal to the axis of the drive shaft 16, against the effect of the resilient return means 17, between at least:
a rotational-linking position in which the balls 18 are housed in two of the diametrically opposite blocking elements 151 so that the drive shaft 16 and the selection member 15 are linked in rotation (cf. FIGS. 16 and 22), and
a release position in which the balls 18 are not housed in any of the blocking housings 151, but are in the grooves 152, so that the drive shaft 16 and the selection member 15 are not linked in rotation.

When the selection member 15 is in the position of deselection of the additional gear train, the blocking balls 18 are housed in two first of the opposite housings 151 (cf. FIG. 16). When the selection member 15 is in the position of selection of the additional gear train, the balls 18 are in two other of the opposite housings 151 (cf. FIG. 22).

When the balls are in their rotational-blocking position, the rotational-linking means are capable of transmitting a predetermined limit torque CI beyond which the balls go into their release position in which the drive shaft and the selection member are no longer linked in rotation and can no longer transmit torque. This predetermined torque depends in particular on the stiffness of the spring 17, the size of the balls, the geometry of the blocking housings and the grooves. This torque can be conventionally determined by calculation or empirically.

The device conventionally comprises means for measuring the tightening torque delivered by the device at the output member. These measuring means can for example comprise a torque sensor placed in the transmission between the rotor and the output member or a sensor of current consumed by the motor.

The device conventionally comprises means for controlling the motor. These means allow to control the motor by controlling in particular its electric power supply.

The means for controlling the motor allow, by acting on the acceleration/deceleration of the rotor of the motor, to make the engagement means go from one to the other of their states, i.e. to make the selection member go from one to the other of its positions with respect to the drive shaft.

To allow the engagement means to go from one to the other of their positions, the acceleration/deceleration generated by the motor must be greater than the quotient of the limit torque CI transmittable by the rotational-linking means divided by the inertia Jos of the selection member according to its axis of rotation. This acceleration/deceleration is called change of speed acceleration/deceleration insofar as it allows to engage/disengage the additional gear train and thus modify the reduction ratio of the transmission between the rotor and the output member.

While a screw driving operation is being carried out, the motor conventionally produces accelerations and acceleration variations, in particular upon starting. The acceleration/deceleration that induces the passage of the engagement means from one to the other of their states should therefore be sufficiently discriminating, i.e. distant and more precisely greater, to the accelerations conventionally capable of occurring to not engender in an untimely manner involuntary passages of the selection means from one to the other of their states.

The transmission comprises a planetary gearset comprising a sun gear 20 constrained to rotate with the drive shaft 16, a carrier 21 constrained to rotate with the output member 12, and an inner toothed ring gear 22 meshing with planet gears 23 carried by the carrier 21.

The two-speed mechanism comprises a ring for driving in rotation 24 the ring gear 22.

This ring for driving in rotation 24 comprises two male teeth 240 cooperating with two female teeth 220 made in the ring gear 22 so that the ring gear 22 and the ring for driving in rotation 24 are linked in rotation according to the axis of the rotor. However, there is play between the male and female teeth to allow the unblocking of the unidirectional clutches.

A longitudinal inner bore 241 housing on one side the selection member 15 and on the other side the ring gear 22 passes through the ring for driving in rotation 24. Two diametrically opposite openings 242 located at the ring gear 22 pass through the peripheral wall of the drive ring 24.

The ring for driving in rotation 24 has at its opposite end, i.e. on the selection member side, longitudinally protruding tooth spaces 243.

The selection member 15 comprises, at its end opposite to the rotor, two diametrically opposite grooves 154. These grooves 154 stretch at the outer periphery of the inner bore and their radial depth shrinks from one end to the other to form ramps (or cams). The grooves 154 are symmetrical with respect to the axis of the selection member.

The device comprises at least one rotational-locking member, two in this embodiment, although there could be more. Each locking member comprises an axis 26 at an end of which a flat section 260 is formed.

A second through-hole 162 made parallel to the first through-hole 160 passes through the drive shaft 16. The end 261 without a flat section of the locking members is housed in this second hole 162. A resilient return means, here a compression spring 27, is placed in the second hole 162 between the locking members 26. The locking members are thus linked in rotation to the drive shaft 16.

The flat section 260 of each locking member 26 bears against one of the ramps of the grooves 154 of the selection member 15 against which it is kept bearing by the return means. The protruding part 262 extending at the end of the flat section 260 of each locking member 26 extends longitudinally outside of the selection member 15.

When the selection member 15 moves from one to the other of its extreme positions with respect to the drive shaft 16, the flat section 260 of each locking member 26 slides along the corresponding ramp formed in the groove 154 in which it is located. Therefore, each locking member 26 is mobile between:
a rotational-blocking position, occupied when the selection member 15 occupies its position of deselection of the additional gear train, in which it protrudes radially at the surface of the selection member 15 and cooperates with one of the blocking housings 244 defined in the drive ring 24 by two consecutive tooth spaces 243 so that said drive ring 24 and said rotor 131 are linked in rotation (cf. FIGS. 15, 17 and 18), and
a rotational-unblocking position, occupied when the selection member 15 occupies its position of selection of the additional gear train, in which it does not protrude radially outside of the selection member 15 and does not cooperate with any of the blocking housings 244 defined in the drive ring 24 by two consecutive tooth spaces 243 so that the drive ring 24 and the rotor 131 are not linked in rotation (cf. FIGS. 21, 23 and 24).

The ring gear 22 has, at its periphery, two pairs of diametrically opposite blocking ramps 221.

The device comprises a pair of unidirectional clutches comprising the ring gear 22, the case 10 forms a unidirectional clutch, and rollers 25 are housed, between the ring gear 22 and the case 10, in the openings 242 of the ring for driving in rotation 24 at the ramps 221 of the ring gear 22. The drive ring 24 allows, according to its position, to activate one or the other of the unidirectional clutches of this pair or to deactivate both of them, as will be described in more detail below.

The ramps 161 are made at the periphery of the drive shaft 16. They are grouped together in opposite pairs with respect to a plane passing through the longitudinal axis of the drive shaft. The ramps 161 of each pair of ramps are symmetrical with respect to a plane passing through the longitudinal axis of the drive shaft 16 and perpendicular to the previous plane. The ramps 161 of each pair are joined by a plate 1610 that extends in a plane parallel to the longitudinal axis of the drive shaft 16. Starting from this plate, they are inclined in the direction of the longitudinal axis of the drive shaft.

The position and the inclination of the ramps 221 of the ring gear 22 are chosen in such a way that:
when the rotational-locking members 26 occupy the rotational-blocking position, the pair of unidirectional clutches leaves the inner toothed ring gear 22 free in rotation (cf. FIGS. 15 to 20),
when the rotational-locking members occupy the rotational-unblocking position, the pair of unidirectional clutches blocks the inner toothed ring gear in rotation (cf. FIGS. 21 to 26).

In alternatives, one or more permanent, i.e. non-deactivatable, gear trains, for example planetary, can be disposed between the carrier 21 and the output member 12.

When the additional gear train is disengaged, the reduction ratio of the transmission is equal to 1 insofar as the drive shaft 16 and the carrier rotate at the same frequency of rotation, or to the reduction ratio of the permanent gear train or to their product if several permanent trains are implemented.

When the additional gear train is engaged, the reduction ratio of the transmission is equal to the reduction ratio of the additional planetary gearset, or to its product with the reduction ratio(s) of the permanent gear train(s) implemented if applicable.

5.2.2. Operation

A screw driving operation comprising a phase of pre-tightening at a fast speed followed by a phase of tightening at a slower speed is described below.

Before starting a screw driving operation, the operator tasked with it programs in the controller, for example via a touch screen, a keyboard, a smartphone or other, the value of the predetermined change of speed torque threshold CchangementVitesse which, when it is reached at the output of the screw driving device during a pre-screw driving phase, engenders a change of speed and the passage into the tightening phase. The operator can also program the value of the target torque to which they desire the assembly to be screwed to be tightened after the tightening phase.

Upon starting of the screw driving device with a view to carrying out such a screw driving operation, the control means control the motor in such a way that it generates, in the direction of the screwing, a change of speed acceleration w, the value of which is greater than the quotient of the predetermined limit torque

$$Cl ( \dot{w} > \frac{Cl}{Jos} ) ,$$

beyond which the balls go into their release position in which the drive shaft and the selection member are no longer linked in rotation, divided by the inertia Jos of the selection member. In this way, the means for engagement of the additional gear train are placed in their disengagement state. The control means then control the motor so as to make it rotate in the direction of the screwing to carry out the pre-screw driving phase.

In the position of disengagement of the additional gear train, the locking members 26, given the relative position of the selection member 15 with respect to the drive shaft 16, are in the blocking position so that the drive shaft 16 and the drive ring 24 are linked in rotation.

The motor is driven in the direction of the screwing, which is here the counterclockwise direction when the device is viewed from the output member towards the rear of the screwdriver, and the ring for driving in rotation 24 rotates in the counterclockwise direction and drives in rotation in this direction the ring gear 22, the unidirectional clutch not meshing the ring gear 22 with the case 10 so that the ring gear 22 is free to rotate.

The ring gear 22 meshes with the planet gears 23 just like the sun gear 20 constrained to rotate with the drive shaft 16. The ring gear 22 thus rotates at the same frequency of rotation as the sun gear 20. As a result, the carrier 21 rotates at the same frequency as the drive shaft 16. Thus, the output member 12 is driven in rotation in the direction of the screwing at a fast speed.

The control means control the motor in such a way that the output member is driven in rotation at a fast speed during the pre-screw driving phase until the tightening torque delivered by the screw driving device reaches the predetermined change of speed torque threshold CchangementVitesse.

When the control means detect via the torque sensor that this threshold has been reached, the control means brake the motor in order to engender a change of speed deceleration, the value of which is greater than the quotient of the predetermined limit torque CI divided by the inertia Jos of the selection member. In this way, the selection means are moved into their state of engagement of the additional gear train.

When this acceleration is generated, the balls 18 exit their housings 151 to circulate in the grooves 152 until they are housed in the other blocking housings 151 of the selection member 15. The latter is thus in its position of selection of the additional gear train (cf. FIGS. 21 to 26).

The control means then control the motor so that it reaches its nominal frequency of rotation while generating, however, an acceleration w lower than the change of speed acceleration in order to guarantee that the selection means remain in their state of engagement of the additional gear train; in other words, the acceleration \dot{w} must be such that

$$\dot{w} < \frac{Cl}{Jos} .$$

The control means then control the motor so as to make it rotate in the direction of the screwing to carry out the pre-screw driving phase.

In this position of selection of the additional gear train, when the rotor 131 rotates in the screwing direction, the blocking (or locking) members 26 are in their unblocking position so that the drive shaft 16 is not linked in rotation to the ring for driving in rotation 24 so that the latter is immobile in rotation. The unidirectional clutch meshes the case 10 with the ring gear 22 so that the latter is immobilized in rotation.

The drive shaft 16 drives in rotation in the clockwise direction the sun gear 20 which meshes with the planet gears 23 rigidly connected to the carrier 21 which rotates to drive in rotation the output member 12 according to a slower speed while providing a higher available torque.

The control means thus control the motor until they detect, via the torque sensor, that the target tightening torque to which it is desired to tighten the assembly currently being screwed has been reached.

The torque sensor can be a measurement of current. It could be possible to cause the engagement disengagement of the additional train on the basis of a reason other than the measurement of torque, for example a measurement of time.

When the target torque has been reached, the control means brake the motor preferably with a deceleration lower than the change of speed deceleration until the frequency of rotation of the motor becomes zero. However, braking with a greater deceleration would not have an effect given that the torque of sliding of the selection member 15 with respect to the drive shaft 16 is substantially greater when the balls no longer have the opportunity to go into a groove 152.

At an equal frequency of rotation of the motor during the phases of fast pre-tightening and slow tightening, the difference in speed of the output member is due to the fact that during the pre-screw driving phase, the ring gear is free in rotation whereas it is immobile in rotation during the tightening phase. In other words, the additional gear train is disengaged during the pre-screw driving phase but engaged during the tightening phase. Thus, the transmission chains used during these two phases have different transmission ratios.

In this embodiment, the motor rotates in the counterclockwise direction for a screwing operation and in the clockwise direction for an unscrewing operation viewed from the output member towards the rear of the screwdriver. These directions of rotation could be reversed in alternatives.

If an acceleration is required in order for the selection means to go from their state of disengagement of the additional gear train to their state of engagement of the additional gear train, a deceleration is necessary to go from their state of disengagement of the additional gear train to their state of engagement of the additional gear train to their state of disengagement of the additional gear train to their state of disengagement of the additional gear train, and vice versa.

Moreover, the driving of the motor in the unscrewing direction while the means for engagement of the additional gear train are placed in their disengagement state allow to carry out a driving in rotation of the output member in the direction of the unscrewing at a fast speed.

The driving of the motor in the unscrewing direction while the means for engagement of the additional gear train are placed in their engagement state allow to carry out a driving in rotation of the output member in the direction of the unscrewing at a slow speed.

### 5.3. Method

FIG. 32 illustrates in a general manner a method for controlling a device according to one or the other of the embodiments described above.

Such a method comprises a step 320 of starting the screwdriver by pressing the trigger.

The method continues by a step 321 of acceleration of the motor in the direction of the screwing with an acceleration

$$\dot{w} > \frac{Cl}{Jos}$$

in such a way that the selection member moves into a position such that the means for engagement of the additional gear train are located in their disengagement state (step 322).

The method continues by a step 323 of maintaining the rotation of the motor at a pre-screw driving frequency.

When it is detected that the tightening torque delivered by the screwdriver exceeds a change of speed torque threshold CchangementVitesse (step 324), a step 325 of deceleration of the motor is implemented with a deceleration

$$\dot{w} < \frac{Cl}{Jos} .$$

Under the effect of this deceleration, the selection member moves into a position such that the means for engagement of the additional gear train are in their engagement state (step 326).

The method continues by a step 327 of acceleration of the motor in the direction of the screwing with an acceleration

$$\dot{w} < \frac{Cl}{Jos} .$$

The motor is driven in rotation until it is detected (step 328) that the tightening torque delivered by the screwdriver reaches the predetermined target tightening torque to which it is desired to tighten the assembly currently being screwed.

When this threshold is reached, the motor is stopped (step 329).

An exemplary embodiment of the present disclosure provides an effective solution to at least some of these various problems.

An exemplary embodiment of the present disclosure provides a two-speed screw driving device that is polyvalent in terms of change of speed.

An exemplary embodiment of the present disclosure provides such a two-speed screw driving device that allows to go from one speed to the other independently of the value of the tightening torque reached.

An exemplary embodiment of the present disclosure provides a two-speed mechanism that has a simple design and is polyvalent.

In particular, at least one embodiment obtains a two-speed mechanism that is easy to integrate into various screw driving devices.

1. A screw driving device comprising:
a case;
a motor provided with a rotor;
an output member capable of driving in rotation an element for driving an element to be screwed;
a transmission connecting said rotor to said output member, said transmission comprising at least one additional gear train capable of being engaged/disengaged;
means for controlling said motor;
said device comprising means for engaging said additional gear train, said engagement means being capable of being in at least:
an engagement state in which said additional train is engaged, and
a disengagement state in which said additional gear train is not engaged,
a reduction ratio of said transmission between said rotor and said output member being different according to whether or not said additional gear train is engaged, said reduction ratio being greater when said additional gear train is engaged,
wherein said means for controlling said motor are configured to generate a predetermined acceleration or deceleration of said rotor, said predetermined acceleration or deceleration acting on said engagement means to make them go from one to the other of their states.

2. The screw driving device according to claim 1, wherein said engagement means comprise a selection member mobile in rotation with respect to said rotor between at least two positions of engagement/disengagement of said additional gear train,
said predetermined acceleration or deceleration acting on said selection member to make it go from one to the other of its positions.

3. The screw driving device according to claim 2, comprising means for rotationally linking said selection member to said rotor, said rotational-linking means ensuring, when said selection member occupies one of its positions, a link in rotation of said selection member to said rotor as long as said motor delivers an acceleration-deceleration lower than a predetermined change of speed acceleration-deceleration threshold, the delivery by said motor of an acceleration/deceleration greater than said predetermined change of speed acceleration-deceleration threshold causing the rotation of said selection member from one to the other of its positions.

4. The screw driving device according to claim 3, wherein said rotational-linking means comprise at least one blocking element constrained to rotate with said rotor and capable of being housed alternatingly in two housings having a complementary shape made in said selection member, said blocking element being mobile according to an axis orthogonal to the axis of said rotor, against the effect of resilient return means, between at least:
a rotational-linking position in which said blocking element is housed in one or the other of said housings so that said rotor and said selection member are linked in rotation, and
a release position in which said blocking element is not housed in any of said housings so that said rotor and said selection member are not linked in rotation.

5. The screw driving device according to claim 4, wherein:
said rotational-linking means are capable of transmitting a predetermined limit torque CI beyond which said rotor and said selection member are no longer linked in rotation and can no longer transmit torque,
said selection member has an inertia Jos according to its axis of rotation;
a value of said change of speed acceleration-deceleration being equal to the quotient of said limit torque CI divided by said inertia Jos.

6. The screw driving device according to claim 1, wherein said transmission comprises at least one planetary gearset comprising a sun gear constrained to rotate with said rotor, a carrier constrained to rotate with said output member, and an inner toothed ring gear meshing with planet gears carried by said carrier, said ring gear being:
mobile in rotation with respect to said case in said state of disengagement of said additional gear train, and
blocked in rotation with respect to said case in said state of engagement of said additional gear train.

7. The screw driving device according to claim 6, comprising a first pair of unidirectional clutches comprising said case and said inner ring gear.

8. The screw driving device according to claim 7, comprising a second pair of unidirectional clutches comprising said rotor and a ring for driving in rotation,
said second pair of unidirectional clutches meshing said rotor with said ring for driving in rotation when said engagement means are in said state of disengagement of said additional gear train and said rotor rotates in the screwing direction, said first pair of unidirectional clutches leaving said inner toothed ring gear free in rotation,
said second pair of unidirectional clutches not meshing said rotor with said drive ring when said engagement means are in said state of engagement of said additional gear train and said rotor rotates in the screwing direction, said first pair of unidirectional clutches blocking said inner toothed ring gear in rotation.

9. The screw driving device according to claim 8, wherein:
said second pair of unidirectional clutches does not mesh said rotor with said drive ring when said engagement means are in said state of disengagement of said additional gear train and said rotor rotates in the unscrewing direction, said first pair of unidirectional clutches blocking said inner toothed ring gear in rotation,
said second unidirectional clutch does not mesh said rotor with said drive ring when said engagement means are in said state of engagement of said additional gear train and said rotor rotates in the unscrewing direction, said first pair of unidirectional clutches leaving said inner toothed ring gear free in rotation.

10. The screw driving device according to claim 7, comprising at least one member for locking in rotation, constrained to rotate with said rotor, and mobile between:
a rotational-blocking position, occupied when said engagement means are in said state of disengagement of said additional gear train, in which it cooperates with a blocking housing made in said drive ring in such a way that said ring and said rotor are linked in rotation, and
a rotational-unblocking position, occupied when said engagement means are in said state of selection of said additional gear train, in which it does not cooperate with said blocking housing made in said drive ring in such a way that said ring and said rotor are not linked in rotation.

11. The screw driving device according to claim 10, wherein:
when said rotational-locking member occupies said rotational-blocking position and said rotor rotates in the screwing direction, said first unidirectional clutch leaves said inner toothed ring gear free in rotation,
when said rotational-locking member occupies said rotational-unblocking position and said rotor rotates in the screwing direction, said first unidirectional clutch blocks said inner toothed ring gear in rotation.

12. The screw driving device according to claim 10, wherein:
when said rotational-locking member occupies said rotational-blocking position and said rotor rotates in the unscrewing direction, said first unidirectional clutch leaves said inner toothed ring gear free in rotation,
when said rotational-locking member occupies said rotational-unblocking position and said rotor rotates in the unscrewing direction, said first unidirectional clutch blocks said inner toothed ring gear in rotation.
